(19) United States
(12) Patent Application Publication
(10) Pub. No.: US 2009/0070243 A1
(43) Pub. Date: Mar. 12, 2009

(54) Local cost computation accounting for a print job

(75) Inventors: Kenneth James Buck, Webster, NY (US); Vanditha Mukund, Penfield, NY (US)

Correspondence Address: Xerox Corporation (CDFS), 445 Broad Hollow Rd.-Suite 420, Melville, NY, 11747, US

(73) Assignee: Xerox Corporation

(21) Appl. No.: 11/900,517

(22) Filed: Sep. 12, 2007

(51) Int. Cl. G06Q 30/00; G06F 17/30; G06Q 99/00

(52) U.S. Cl. 705/34; 705/30; 705/400

(57) ABSTRACT

A system for accounting for a print job includes at least one print device having at least one control software module and a server having a funds deposition mechanism storing deposited funds in a funds database. The server communicates with the print device via a network transporting at least one signal. The signals are transported via the network through a network interconnection between the server and the print devices.

### CROSS-REFERENCE TO RELATED APPLICATIONS

This application is related to commonly owned and concurrently filed U.S. patent application Ser. No. {Attorney Docket No. 20061622Q (1515-85Q} by K. J. Buck et al., entitled “LOCAL COST COMPUTATION ACCOUNTING FOR A PRINT JOB”; U.S. patent application Ser. No. {Attorney Docket No. 20061623-US-NP (1515-78} by K. J. Buck et al., entitled “DATA PROCESSING CARD BASED COPY BILL PAYMENT CAPABILITY”; U.S. patent application Ser. No. {Attorney Docket No. 20061623Q-US-NP (1515-78Q)} by K. J. Buck et al., entitled “DATA PROCESSING CARD BASED COPY BILL PAYMENT CAPABILITY”; U.S. patent application Ser. No. {Attorney Docket No. 20061633-US-NP (1515-80)} by V. Mukund et al., entitled “INTEGRATED ADAPTABLE ACCOUNTING SYSTEM FOR A PRINT JOB”; and U.S. patent application Ser. No. {Attorney Docket No. 20061634-US-NP (1515-79)} by V. Mukund et al., entitled “DISTRIBUTED LIMIT-BASED ACCOUNTING FOR PRINT JOBS”, the entire contents of each of which is incorporated by reference herein.

### BACKGROUND

1. Technical Field

The present disclosure relates to accounting systems and methods, and more particularly, to accounting methods and machines for effecting accounting control for print jobs.

(As defined herein, a print job is print output from a device that produces a print output, e.g., a copier, a scanner, a facsimile machine, a printer, a multifunction device (MFD) or other suitable image forming device. As defined herein, a print job is also an action by, or a function of, a device that produces a copy-to-file, a print-to-file, a scan-to-file, a facsimile-to-file, and a multifunction device or other suitable image forming device performing the same actions or functions to file.)

2. Description of Related Art

There is a difference between accounting for pure tracking and accounting to ensure that the user stays within pre-specified limits. Limits can be applied in two ways: (1) in terms of number of images that can be printed/copied, and (2) in terms of availability of funds. Limit based accounting that is related to availability of funds requires real time computation of the customer's bill, comparison against the customer's available funds and stopping the billable function when funds run out. For copiers, such limit based accounting has historically been done using currency based hardwire connected foreign device interfaces (FDI), also referred to as vending boxes, which bill by each page that is copied.

Traditionally, FDIs have been used for controlling copy activity with direct debiting of funds. The interface has been a very simple 5-wire or equivalent interface, where one wire is used for enabling the marking on the MFD, one is reserved for ground, one wire communicates page clicks from the marking engine, while the remaining two wires are used to indicate premium features such as color or large paper. The cost of a marked page is calculated by the vending device on the basis of the activation level of the three image information carrying wires, and the amount debited from the available funds. Essentially, deposit of the necessary funds in the vending machine turns the “enable” wire high, thereby indicating to the device that marking can take place.

### SUMMARY

To provide advancement over prior art systems and methods for accounting for a print job, according to aspects illustrated herein, there is provided a system for accounting for a print job wherein the system includes at least one print device having at least one control software module and a server having a funds deposition mechanism storing deposited funds in a funds database. The server communicates with the one or more print devices via a network transporting at least one signal. The one or more signals are transported via the network through a network interconnection between the server and the one or more print devices.

The network connection between the server and the one or more print device(s) may be, but is not limited, to an Ethernet connection, a serial port, a hard-wired connection, a wireless connection, a universal serial bus (USB), an RS232 serial interface, and a Firewire connection.

### BRIEF DESCRIPTION OF THE DRAWINGS

Various embodiments of the present disclosure will be described herein below with reference to the figures wherein:

FIG. 1 illustrates a cost computation accounting system for a print job according to the prior art;

FIG. 2 is a schematic diagram for a local cost computation accounting system according to one embodiment of the present disclosure; and

FIG. 3 is a schematic diagram for a local cost computation accounting system according to another embodiment of the present disclosure.

### DETAILED DESCRIPTION

The present disclosure relates to an extensive limit based billing system that accommodates customer-unique cost structures and that monitors different kinds of jobs (e.g. copy, print, fax send) and allows variable charging for several premium options (e.g. large paper, color, duplex).

As defined herein, a print device refers to a device that produces a print output, e.g., a copier, a scanner, a facsimile machine, a printer, a multifunction device (MFD) or other suitable image forming device. Alternatively, a print device refers to a device that produces a copy-to-file, a print-to-file, a scan-to-file, a facsimile-to-file, and a multifunction device or other suitable image forming device performing the same functions to file. A print device may include an internal processor capable of hosting a database, e.g., a master print device, a slave print device having at least one database, or a slave print device not having a database.

Also as used herein, the terms dynamically and dynamic refer to an action occurring at the time of need for the action to occur or for an object to be created, as opposed to the capability of the action occurring having been established or the object being created a priori.

More particularly, the local cost computation accounting according to the present disclosure enables monitoring of several print job types based on funds availability, while allowing for several premium options to be considered in the cost structure. The cost computation can be done locally on the print device or remotely on a server, at the time of need, thereby allowing for dynamic update of available funds. The local cost computation accounting allows integration with authentication mechanisms such as card readers, thereby allowing for various methods of funds input including credit/debit cards, stored value cards, etc. The solution is independent of the physical interface between the print device and the funds vending device. Thus, the same method and application interface may work over Ethernet, Serial Port, USB or other physical interface. The architecture is independent of the location of the cost computation.

The method of local cost computation accounting according to the present disclosure enables complex billing models to be dynamically applied based on user identity, geographic location of user (e.g. for sales tax computation), site dependencies, etc. The location of cost computation is not restricted to the print device. Where network trip times are reasonable, the cost computation can take place on a server. The methodology according to the present disclosure enables application and employment of Stored Value Card and Credit Card to current Currency based machines. The methodology according to the present disclosure emulates FDI hardwire based systems but expands system capability to accommodate a greater number of premium signals.

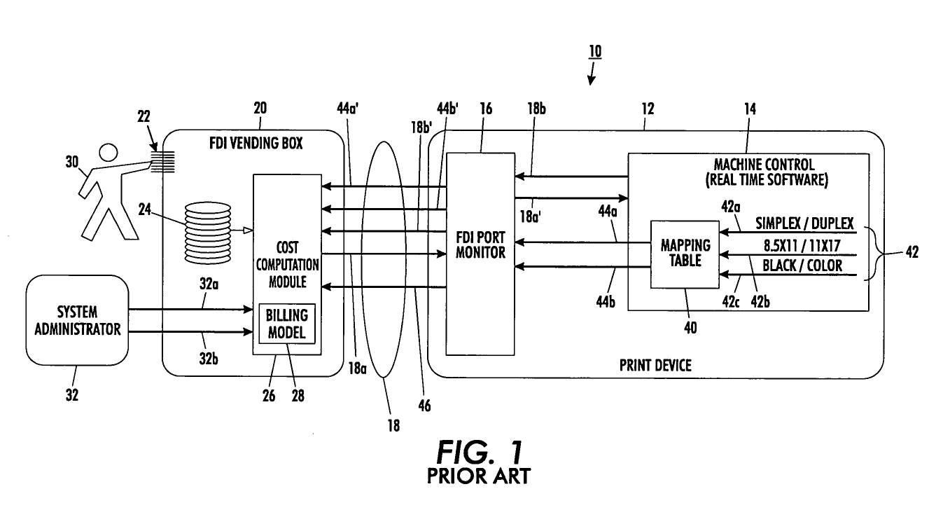

Referring to FIG. 1, there is disclosed a system for local cost accounting for a print job according to the prior art. The system 10 includes a print device 12 having a real-time operating software module 14 and a foreign device interface (FDI) port monitor 16. The system 10 also includes an FDI vending box 20 that interfaces with the print device 12 via an FDI 18 that is configured by hardwired cables. The FDI vending box 20 has a funds deposition mechanism 22 that enables storing funds deposited by a user 30 in a funds database 24. The FDI vending box 20 also includes a cost computation module 26 communicating with the funds database 24. The cost computation module 26 calculates the cost of the print job based on costs for print job actions stored in a print job billing module 28 that may reside in the cost computation module 26. The prices or charges for print job actions stored in the print job billing module 28, such as cost per page 32a or cost per premium service or option 32b, may be established by a system administrator 32 such as a store manager.

When funds are deposited in the funds deposition mechanism 22 and the action communicated to the funds database 24, the funds database 24 communicates the amount of funds deposited to cost computation module 26 which compares the amount of funds deposited to the prices or charges for print job actions stored in the print job billing module 28. If sufficient funds are now available, the cost computation module 26 residing on the vending box 20 communicates an enable signal 18a via a hardwired cable to the operating software module 14 of the print device 12 through the FDI port monitor 16 as an enable paper feed signal 18a′ from the FDI port monitor 16 to the operating software module 14.

The operating software module 14 includes a mapping table 40 that converts job parameter signals 42 into premium signals 44a and/or 44b, as applicable. The job parameter signals 42 represent basic services such as a paper side copy parameter 42a, e.g., whether the print job request is for a simplex or single-sided copy versus a duplex or double-sided copy that is a premium service, a paper size parameter 42b, e.g., whether the print job request is for an 8.5 inch×11 inch paper size versus a premium size such as an 11 inch×17 inch paper size, or other size, and a print color copy parameter 42c, e.g., whether the print job request is for a black and white copy versus a premium service of a color copy.

If any premium job parameter signals 42 are selected, the mapping table 40 converts one or more of the specific job parameter signals 42a, 42b or 42c into the premium signals 44a and/or 44b and communicates the signals 44a and/or 44b as premium signals 44a′ and/or 44b′ from the FDI port monitor 16 to cost computation module 26 residing on the vending box 20.

As described above, if the funds deposited in the funds database 24 are sufficient for the price or charge of the print job request, the cost computation module 26 residing on the vending box 20 communicates the enable signal 18a via a hardwired cable to the operating software module 14 of the print device 12 through the FDI port monitor 16 as an enable paper feed signal 18a′ from the FDI port monitor 16 to the operating software module 14. Upon completion of one page of the print job request, the operating software module 14 generates a page delivered signal 18b that is communicated to the cost computation module 26 as a click signal 18b′ through the FDI port monitor 16 also in a hardwired cable in the FDI 18. The click signal 18b′ enables the cost computation module 26 to compute the price or charge for the print job. Upon completion of the print job, the operating control software module 14 communicates a return signal 46 to the cost computation module 26 on the vending box 20 to return the system 10 to a non-enabled state pending receipt of another print job.

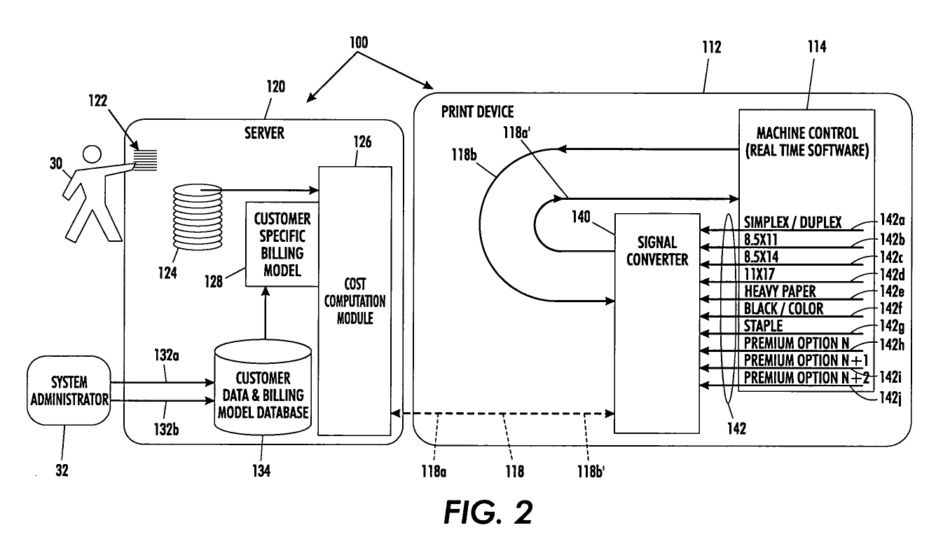

Referring to FIG. 2, there is disclosed one embodiment of a system for accounting for a print job according to the present disclosure. More particularly, system 100 for accounting for a print job includes at least one print device 112 having at least one control software module 114 and a server 120 having a funds deposition mechanism 122 that enables storing deposited funds, that may be deposited by the user or print job requester 30, in a funds database 124. The server 120 communicates with the one or more print devices 112 via a network 118 that transports at least one signal 118a through a network interconnection 118′ between the server 120 and the print device(s) 112.

In one example, the signal(s) 118a enable operation of the print device(s) 112 based on the funds deposited in the funds database 124 via the funds deposition mechanism 122 of the server 120.

As illustrated in FIG. 2, in one embodiment, the server 120 includes at least one cost computation module 126, and the print device(s) 112 further include at least one signal converter module 140 that is configured to receive from the one or more control software module(s) 114 at least one job parameter signal and to convert the one or more job parameter signal(s) 142 to at least one signal indicative of a job parameter for the print job. Signals 142 indicative of a job parameter for the print job are similar to the signals 42 discussed above with respect to system 10. More particularly, job parameter signals 142 indicative of a job parameter for the print job represent basic services such as a paper side copy parameter 142a, e.g., whether the print job request is for a simplex or single-sided copy versus a duplex or double-sided copy that is a premium service; a paper size parameter 142b, 142c or 142d, e.g., whether the print job request is for an 8.5 inch×11 inch paper size versus a premium size such as an 8.5 inch×14 inch or an 11 inch×17 inch paper size, respectively, or other size (e.g., A3 or A4); a paper weight copy parameter 142e, e.g. whether a standard paper weight or a heavy paper weight is desired; a print color copy parameter 142f, e.g., whether the print job request is for a black and white copy versus a premium service of a color copy; a paper attachment parameter 142g, e.g., whether the print job request is for stapled pages; and for at least one premium option for the print job, e.g., additional unspecified premium options N, N+1, N+2 . . . or signals 142h, 142i or 142j . . . , respectively, for the print job.

The network connection 118′ between the server 120 and the print device(s) 112 may be an Ethernet connection, a serial port, a hard-wired connection, and/or a wireless connection or other suitable interface or connection including a suitable interface or connection that enables intelligent connection between client and server, as opposed to binary on and off signals. Examples of intelligent connections include a single wire over which to conduct serial communication. Specifically, RS232 serial interface or USB (universal serial bus) or Firewire are other serial protocols that are non-limiting examples of suitable intelligent connections that are forms of bi-directional serial communication that operate at a higher level of intelligence than the on/off binary protocol of the existing interface.

The system 100 having the network 118 transporting at least one signal through the network interconnection 118′ between the server 120 and the print device(s) 112 enables multiple premium option signals beyond those available by the hard wire interconnection of the FDI 18 of the prior art discussed above for system 10 (see FIG. 1).

The one or more signals indicative of a job parameter 142 may be transported between the one or more signal converters 140 residing on the print device(s) 112 and the one or more cost computation modules 126 residing on the server 120 via the network interconnection 118′ between the server 120 and the print device(s) 112.

The signal(s) 118a enabling operation of the print device(s) 112 may be communicated as a converted enabling signal 118a′ between the signal converter module(s) 140 and the control software module(s) 114. As indicated above, the server 120 communicates with the print device(s) 112 via the network 118 that transports at least one signal 118a through the network interconnection 118′.

In one example, the signal(s) 118a enable operation of the print device(s) 112 based on the funds deposited in the funds database 124, e.g., by the user 30, via the funds deposition mechanism 122 of the server 120. The funds may be deposited at the funds deposition mechanism 122 in the form of currency, or via a data processing card such as a debit or credit card, or other suitable mechanism.

Upon completing printing of at least one page of the print job, the control software module(s) 114 generates or generate at least one print page delivered signal 118b that indicates completion of printing of at least one page of the print job. The print page(s) delivered signal 118b may be converted to a signal 118b′ via the signal converter(s) 140 and transported to the cost computation module(s) 126 residing on the server 120 via the network interconnection 118′ of the network 118

The server 120 may further include a customer data and billing model database 134 wherein the server 120 is configured to enable dynamic updating of the customer data and billing model database 134 to generate a customer specific billing model 128 for the print job at the time of need that is capable of interfacing with the cost computation module(s) 126 for computation of the cost of the print job. The dynamic updating of the customer data and billing model database 134 is enabled by firmware, software and/or hardware residing on the server 120. Thus, the system administrator 32 may implement customer specific instructions such as price or charge per page 132a or per premium option 132b to generate the customer specific billing model 128 for the print job at the time of need.

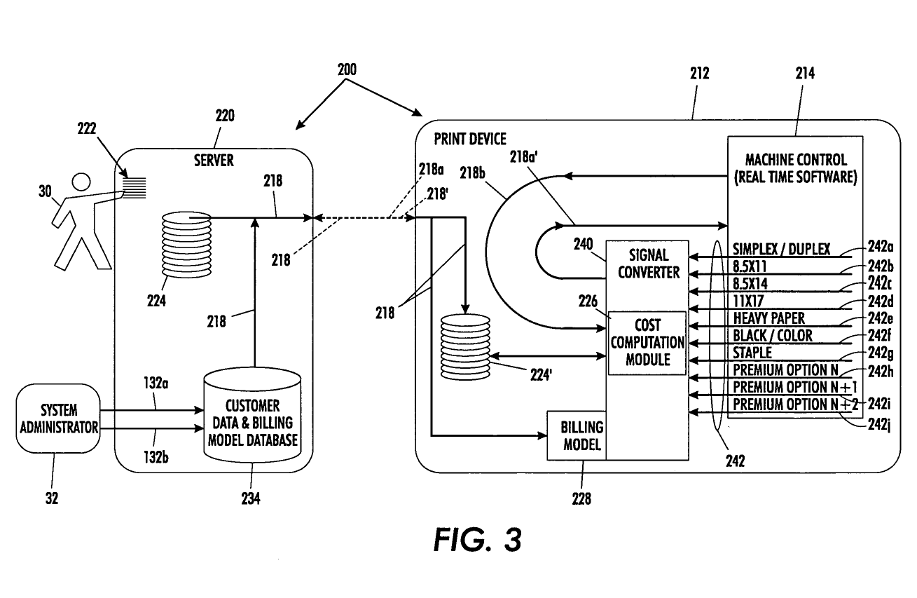

Turning now to FIG. 3, there is illustrated another embodiment of a system for accounting for a print job. More particularly, in a similar manner to system 100 described above, system 200 includes at least one print device 212 having at least one control software module 214 and a server 220 having a funds deposition mechanism 222 that enables storing deposited funds in a funds database 224. The server 220 communicates with the print device(s) 212 via a network 218 that transports at least one signal 218a through a network interconnection 218′ between the server 220 and the print device(s) 212.

In one example, the signal(s) 218a enable operation of the print device(s) 212 based on the funds deposited in the funds database 224, e.g., by the user 30, via the funds deposition mechanism 222 of the server 220. In a similar manner as with respect to system 100, the funds may be deposited at the funds deposition mechanism 222 in the form of currency, or via a data processing card such as a debit or credit card, or other suitable mechanism.

The system 200 differs from the system 100 in that the print device(s) 212 further includes or includes at least one cost computation module 226, included within signal converter 240, that is configured to receive from the control software module(s) 214 at least one job parameter signal 242 indicative of a job parameter for the print job. Signals 242 indicative of a job parameter for the print job are similar to the signals 142 discussed above with respect to system 100, except that the job parameter signals 242 now interface or are communicated to the cost computation module 226, via the signal converter 240 on the print device 212, rather than to the cost computation module 126 on the server 120 via the signal converter 140 (see FIG. 2). More particularly, job parameter signals 242 indicative of a job parameter for the print job represent basic services such as a paper side copy parameter 242a, e.g., whether the print job request is for a simplex or single-sided copy versus a duplex or double-sided copy that is a premium service; a paper size parameter 242b, 242c or 242d, e.g., whether the print job request is for an 8.5 inch×11 inch paper size versus a premium size such as an 8.5 inch×14 inch or an 11 inch×17 inch paper size, respectively, or other size (e.g., A3 or A4); a paper weight copy parameter 242e, e.g. whether a standard paper weight or a heavy paper weight is desired; a print color copy parameter 242f, e.g., whether the print job request is for a black and white copy versus a premium service of a color copy; a paper attachment parameter 2429, e.g., whether the print job request is for stapled pages; and for at least one premium option for the print job, e.g., additional unspecified premium options N, N+1, N+2 . . . or signals 242h, 242i or 242j . . . , respectively, for the print job.

As opposed to system 100, in system 200 of FIG. 3, at least one signal enabling operation of the print device(s), e.g., signal 218a′ enabling operation of the print device(s) 212, may be communicated between the cost computation module(s) 226 and the control software module(s) 214. The signal(s), e.g., signal 218a′, enables or enable operation of the print device(s), e.g., print device 212, based on the funds deposited in the funds data base 224, e.g., by the user or print job requester 30, via the funds deposition mechanism 222 of the server 220.

In one example, the control software module(s) 214 generates or generate at least one print page delivered signal 218b that indicates completion of printing of at least one page of the print job. The at least one print page delivered signal 218b may be transported to the cost computation module(s) 226 for computation of the cost of the print job. The cost computation module(s) 226 may be configured to receive from the control software module(s) 214 at least one job parameter signal 242 and to convert the at least one job parameter signal 242 to at least one signal indicative of a job parameter for the print job, e.g., paper side copy parameter 242a; paper size parameter 242b, 242c or 242d; paper weight copy parameter 242e; print color copy parameter 242f; paper attachment parameter 242g; and for at least one premium option for the print job, e.g., additional with unspecified premium options N, N+1, N+2 . . . or signals 242h, 242i or 242j . . . , respectively, for the print job, as described above.

The print device(s) 212 may further include a local funds cache 224′. The one or more job signals 242 is/are communicated to the local funds cache 224′. The funds database 224 residing in the server 220 communicates with the local funds cache 224′ residing in the print device(s) 212 via the signal(s) 218a being transported via the network interconnection 218′ between the server 220 and the print device(s) 212. The signal(s) 218a may be communicated through the local funds cache 224′ to the cost computation module(s) 226 for computation of the cost of the print job. The server 220 may further include a customer data and billing model database 234. Thus, in a similar manner as with respect to system 100, the system administrator 32 may implement customer specific instructions such as price or charge per page 232a or per premium option 232b to generate a customer specific billing model 228 for the print job at the time of need. The server 220 may be configured to enable dynamic updating of the customer data and billing model database 234 to generate the customer specific billing model 228 for the print job at the time of need that is capable of interfacing with the cost computation module(s) 226 for computation of the cost of the print job. In a similar manner as described above with respect to customer data and billing model database 134, the dynamic updating of the customer data and billing model database 234 is enabled by firmware, software and/or hardware residing on the server 220.

Referring again to FIGS. 2 and 3, those skilled in the art will recognize that and understand how the present disclosure relates also to a method for accounting for a print job. More particularly, the method includes the steps of providing at least one print device having at least one control software module, e.g., at least one print device 112 or 212 having at least control software module 114 or 214, respectively, and a server having a funds deposition mechanism storing deposited funds in a funds database, e.g., the server 120 or 220 having funds deposition mechanism 122 or 222 storing deposited funds in the funds database 124 or 224, respectively, with the server communicating with the at least one print device via a network transporting at least one signal, e.g., with server 120 or 220 communicating with the one or more print device(s) 112 or 212 via the network 118 or 218 transporting at least one signal 118a or 218a, respectively. The method also includes the step of transporting at least one signal enabling operation of the print device(s) via the network through a network interconnection between the server and the print device(s), e.g. transporting at least one signal 118a′ or 218a′ enabling operation of the one or more print device(s) 112 or 212 via the network 118 or 218 through the network interconnection 118′ or 218′ between the server 120 or 220 and the print device(s) 112 or 212, respectively.

The method may further include the step of enabling operation of the one or more print device(s) based on the funds deposited in the funds database via the funds deposition mechanism of the server, e.g., enabling operation of the one or more print device(s) 112 or 212, via print job enabling signal 118a′ or 218a′, based on the funds deposited in the funds database 124 or 224 via the funds deposition mechanism 122 or 222 of the server 120 or 220, respectively.

The method may also include the steps of providing at least one cost computation module and transporting at least one signal indicative of a job parameter for the print job from the control software module(s) to the cost computation module(s), e.g., transporting at least one signal 142 or 242 indicative of a job parameter for the print job from the control software module(s) 114 or 214 to the cost computation module(s) 126 or 226, respectively.

The method may be implemented wherein the signal(s) indicative of a job parameter for the print job includes or includes at least one premium option for the print job, e.g., at least one signal 142 or 242 indicative of a job parameter for the print job includes at least one premium option for the print job, e.g., duplex paper 142a or 242a, paper size 8.5 inch×14 inch 142c or 242c, or paper size 11 inch by 17 inch 142d or 242d, or heavy paper 142e or 242e, or color copy 142e or 242e, or stapled copy 142f or 242f, or other premium options 142h or 242h, 142i or 242i, or 142j or 242j, respectively.

The method may also be implemented wherein the signal(s) indicative of a job parameter is/are transported via the network interconnection between the server and the print device(s), e.g., at least one signal 142 or 242 through a network interconnection 118′ or 218′ between the server 120 or 220 and the print device(s) 112 or 212, respectively.

In addition, the method may be implemented wherein the server further includes a customer data and billing model database, e.g., the server 120 or 220 further includes a customer data and billing model database 134 or 234. The method may further include the step of dynamic updating of the customer data and billing model database to generate a customer specific billing model for the print job capable of interfacing with the cost computation module(s) for computation of the cost of the print job, e.g., dynamic updating of the customer data and billing model database 134 or 234 to generate a customer specific billing model 128 or 228 for the print job at the time of need that is capable of interfacing with the cost computation module(s) 126 or 226 for computation of the cost of the print job, respectively.

Furthermore, the method may be implemented wherein the network connection between the server and the print device(s), e.g., network connection 118 or 218 between the server 120 or 220 and the print device(s) 112 or 212, respectively, may be, as described above, an Ethernet connection, a serial port, a hard-wired connection and/or a wireless connection or other suitable interface or connection including a suitable interface or connection that enables intelligent connection between client and server, as opposed to binary on and off signals. Similarly, examples of intelligent connections include a single wire over which to conduct serial communication, and specifically, RS232 serial interface or USB (universal serial bus) or Firewire are other serial protocols that are non-limiting examples of suitable intelligent connections that are forms of bi-directional serial communication that operate at a much higher level of intelligence than the on/off binary protocol of the existing interface.

From the foregoing disclosure, it can be appreciated that the embodiments of the present disclosure relate to depositing funds on a server. By depositing the funds on the server, an intelligent connection typically via a network connection is enabled between the server and the printer, rather than traditional non-intelligent hard wires only. The network connection increases the number of print or premium options that can be selected. The cost computation module may also reside on the print device. In addition, “dynamic updating”, i.e., updating at the time the information is needed, as opposed to a priori, of the customer data and billing model database, to generate a customer specific billing model, is possible.

It will be appreciated that variations of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

1. A system for accounting for a print job comprising:
at least one print device having at least one control software module; and
a server having a dynamic funds deposition mechanism for manipulating deposited funds in a funds database,
the server communicating with the at least one print device via a network transporting at least one signal,
the at least one signal being transported via the network through a network interconnection between the server and the at least one print device.

2. The system according to claim 1, wherein the at least one signal enables operation of the at least one print device based on the funds deposited in the funds database via the hinds deposition mechanism of the server.

3. The system according to claim 1,
wherein the server further comprises at least one cost computation module, and
wherein the at least one print device further comprises at least one signal converter module configured to receive from the at least one control software module at least one job parameter signal and to convert the at least one job parameter signal to at least one signal indicative of a job parameter for the print job.

4. The system according to claim 3, wherein the at least one signal indicative of a job parameter for the print job includes at least one premium option for the print job.

5. The system according to claim 3, wherein the at least one signal indicative of a job parameter is transported between the at least one cost computation module residing on the server and the at least one signal converter residing on the at least one print device.

6. The system according to claim 5, wherein the at least one signal indicative of a job parameter is transported via the network interconnection between the server and the at least one print device.

7. The system according to claim 3, wherein the at least one signal enabling operation of the at least one print device is communicated between the at least one signal converter module and the at least one control software module.

8. The system according to claim 3,
wherein the at least one control software module generates at least one print page delivered signal indicating completion of printing of at least one page of the print job,
the at least one print page delivered signal being converted via the at least one signal converter and transported to the at least one cost computation module residing on the server via the network interconnection between the server and the at least one print device.

9. The system according to claim 3, wherein the server further comprises a customer data and billing model database.

10. The system according to claim 9, wherein the server is configured to enable dynamic updating of the customer data and billing model database to generate a customer specific billing model for the print job capable of interfacing with the at least one cost computation module for computation of the cost of the print job.

11. The system according to claim 1, wherein the network connection between the server and the at least one print device is one of an Ethernet connection, a serial port, a hard-wired connection a wireless connection, a universal serial bus (USB), an RS232 serial interface, and a Firewire connection.

12. The system according to claim 1, wherein the at least one print device further comprises:
at least one cost computation module configured to receive from the at least one control software module at least one job parameter signal indicative of a job parameter for the print job.

13. The system according to claim 12, wherein at least one signal enabling operation of the at least one print device is communicated between the at least one cost computation module and the at least one control software module.

14. The system according to claim 13, wherein the at least one signal enables operation of the at least one print device based on the funds deposited in the funds database via the funds deposition mechanism of the server.

15. The system according to claim 12,
wherein the at least one control software module generates at least one print page delivered signal indicating completion of printing of at least one page of the print job, and
wherein the at least one print page delivered signal is transported to the at least one cost computation module for computation of the cost of the print job.

16. The system according to claim 12,
wherein the at least one cost computation module is configured to receive from the at least one control software module at least one job parameter signal and to convert the at least one job parameter signal to at least one signal indicative of a job parameter for the print job.

17. The system according to claim 16, wherein the at least one print device further comprises a local funds cache, and wherein the at least one job signal indicative of a job parameter for the print job is communicated to the local funds cache.

18. The system according to claim 17,
wherein the funds database residing in the server communicates with the local funds cache residing in the at least one print device via the at least one signal transported via the network interconnection between the server and the at least one print device, the at least one signal transported via the network interconnection being communicated through the local funds cache to the at least one cost computation module for computation of the cost of the print job.

19. The system according to claim 12, wherein the server further comprises a customer data and billing model database.

20. The system according to claim 19, wherein the server is configured to enable dynamic updating of the customer data and billing model database to generate a customer specific billing model for the print job capable of interfacing with the at least one cost computation module for computation of the cost of the print job.
